(19) United States
(12) Patent Application Publication
(10) Pub. No.: US 2006/0126108 A1
(43) Pub. Date: Jun. 15, 2006

(54) Method, printer, and storage medium for printing a medical image

(75) Inventors: Mohamed N. Ahmed, Louisville, KY (US); Michael E. Lhamon, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/013,521

(22) Filed: Dec. 15, 2004

(51) Int. Cl. G06F 3/12

(52) U.S. Cl. 358/1.15

(57) ABSTRACT

A method for printing at a printer medical images stored in a database of an image-storage server operatively connected to an image-manipulation server. The method includes several steps. One step includes requesting the image-manipulation server to obtain at least one of medical image from the database for a patient identified by an input to a printer. Another step includes displaying on a screen of the printer a thumbnail of the medical image. An additional step includes printing the medical image corresponding to the thumbnail selected by an input to the printer. A storage medium contains a program readable by a computer of a printer to perform the steps. A printer includes a computer including a program to perform the steps.

### TECHNICAL FIELD

The present invention relates generally to printing images, and more particularly to a method, to a printer, and to a storage medium for printing a medical image.

### BACKGROUND OF THE INVENTION

Known systems for printing a medical image include those using a PACS (Picture Archiving and Communication Systems) image-storage server having a memory storing a database of medical images and names of patients corresponding to the medical images. The database is stored in memory in a DICOM (Digital Imaging and Communications in Medicine) file format. The database contains photo-electronic (i.e., digital) medical images such as X-ray images, Computed Tomography (CT) images, Magnetic Resonance (MR) images, UltraSound (US) images, single photon emission computed tomography (SPECT) images, and/or Positron Emission Tomography (PET) images. A high-end graphical workstation is operatively connected to the PACS image-storage server. A skilled user of the workstation, such as an expert radiologist or clinician, can operate the workstation to acquire patient information, display medical images of a patient, scroll through the displayed medical images, convert two-dimensional images to three-dimensional images, and select images for printing.

What is needed is an improved method for printing a medical image.

### SUMMARY OF THE INVENTION

A first aspect of the invention is a method for printing one of a database of medical images, wherein the database includes names of patients corresponding to the medical images, and wherein the database is stored in a memory of an image-storage server operatively connected to an image-manipulation server. The method includes several steps. One step includes requesting the image-manipulation server to obtain a group of medical images from the database for a patient identified by an input to a printer. Another step includes displaying, on a screen of the printer, a thumbnail of at least one medical image from the group. An additional step includes requesting the printer to print a medical image corresponding to a thumbnail identified by an input to the printer.

A second aspect of the invention is a storage medium containing a program which is readable by a digital computer of a printer which is operatively connectable to an image-manipulation server which is operatively connectable to an image-storage server. The image-storage server has a memory storing a database of medical images and names of patients corresponding to the medical images. The program instructs the digital computer to perform several steps. One step includes requesting the image-manipulation server to obtain a group of medical images from the database for a patient identified by an input to the printer. Another step includes displaying, on a screen of the printer, a thumbnail of at least one medical image from the group. An additional step includes requesting the printer to print a medical image corresponding to a thumbnail identified by an input to the printer.

A third aspect of the invention is a printer including a digital computer and a screen operatively connected to the digital computer. The digital computer is operatively connectable to an image-manipulation server which is operatively connectable to an image-storage server. The image-storage server has a memory storing a database of medical images and names of patients corresponding to the medical images. The digital computer includes a program which instructs the digital computer to perform several steps. One step includes requesting the image-manipulation server to obtain a group of medical images from the database for a patient identified by an input to the printer. Another step includes displaying, on the screen, a thumbnail of at least one medical image from the group. An additional step includes requesting the printer to print a medical image corresponding to a thumbnail identified by an input to the printer.

Several benefits and advantages are derived from at least one of the method, the printer, and the storage medium of the invention. In one example, having a printer interact with an image-manipulation server operatively connected to the image-storage server allows personnel to use a printer to retrieve medical images, to display thumbnails of such images, and to print such images without having first received extensive training and without having to operate a high-end graphical workstation.

### BRIEF DESCRIPTION OF THE DRAWINGS

FIG. 1 is a block diagram of a method of the invention; and

FIG. 2 is a schematic diagram of an embodiment of a printer of the invention.

### DETAILED DESCRIPTION

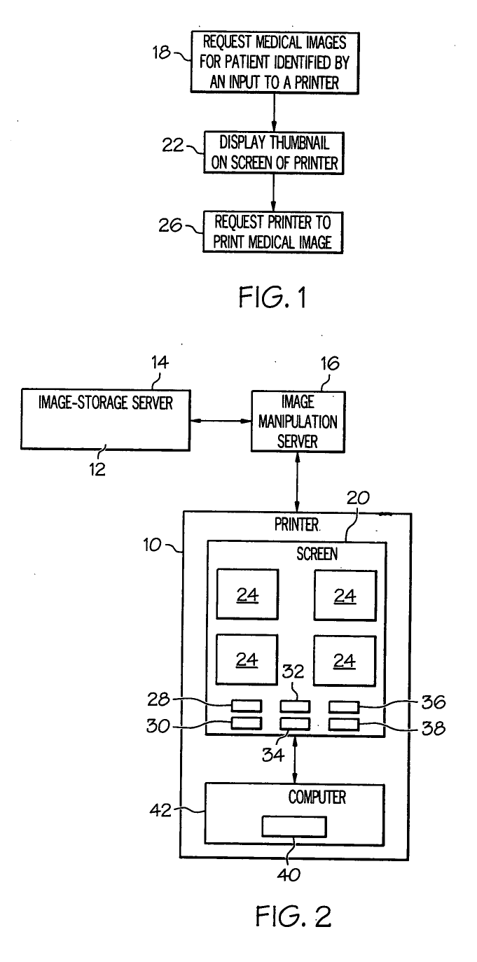

With references to the figures, several embodiment of the present invention will now be shown and described. Like reference numerals are used to indicate the same element throughout the specification. FIG. 1 is a block diagram of a method which is a first aspect of the invention and which, in one enablement, is performed using the embodiment of a printing device or printer 10 shown in FIG. 2. As used herein, a printer may be any device capable of performing a printing function such as a standalone printer or a multifunctional device which performs other functions such as copying, faxing, or scanning in addition to printing. The method is for printing one of the database of medical images, wherein the database includes identifiers corresponding to the medical images, such as names of patients, and wherein the database is stored in an image-storage server 14 operatively connected to an image manipulation server 16. The method includes several steps. One step is labeled as “Request Medical Images For Patient. Identified By An Input To A Printer” in block 18 of FIG. 1. This step includes requesting the image-manipulation server 16 to obtain medical images from the database for a patient identified by an input to the printer 10. Another step is labeled as “Display Thumbnail On Screen Of Printer” in block 22 of FIG. 1. This step includes displaying, on a screen 20 of the printer 10, a thumbnail 24 of at least one medical image. It is noted that four thumbnails 24 (shown as four empty boxes representing reduced-sized medical images) are displayed in the embodiment of FIG. 2. An additional step is labeled as “Request Printer To Print Medical image” in block 26 of FIG. 1. This step includes requesting the printer 10 to print a medical corresponding to a thumbnail 24 identified by an input to the printer.

It is noted that the medical images are photo-electronic (i.e., digital) medical images.

In one illustration of the method, the displaying step includes scrollably displaying a thumbnail 24 of at least one medical image. In this context, by “scrollably displaying” is meant displaying at least one thumbnail and then allowing the user of the printer to interact with the printer to replace one or more of the displayed thumbnails with new thumbnails of other medical images from the group. In one variation, the screen 20 is a touch screen and a scroll touch button 28 displayed on the screen 20 allows the user to scrollably display the thumbnails 24. In another variation, a scroll forward touch button and a scroll backward touch button are displayed. In a further variation, the right side of the scroll touch button is touched to scroll forward and the left side of the scroll touch button is touched to scroll backward. The number and size of the thumbnails are limited by the resolution and size of the screen of the printer and by the number and size of the touch buttons displayed on the screen at the same time the thumbnails are displayed on the screen.

In one example of the method, each of the medical images of the database is stored in a Digital Imaging and Communications in Medicine (DICOM) file format. In the same or a different example, the image-storage server 14 is a Picture Archiving and Communication System (PACS) server. In the same or a different example, the image-manipulation server 16 is a Lexmark Document Distributor (LDD) server. In one application of the method, the group of medical images includes X-ray images, Computed Tomography (CT) images, Magnetic Resonance (MR) images, UltraSound (US) images, single photon emission computed tomography (SPECT) images, and/or Positron Emission Tomography (PET) images.

The method may also include the step of requesting the image-manipulation server 16 to perform an action on a selected thumbnail 24 in response to input received from a user. For example, in one implementation, the method also includes the step of requesting the image-manipulation server 16 to enlarge a thumbnail 24 selected for enlargement by an input to the printer 10. In one variation, the screen 20 is a touch screen and that input is provided by the user touching a zoom touch button 30 displayed on the screen 20. In one example, the user first highlights a particular thumbnail to be enlarged by touching that thumbnail. In one variation, wherein four thumbnails 24 are originally displayed using two rows and two columns, the two-row-and-two-column area displayed on the screen 20 is replaced by a larger single thumbnail.

In the same or a different implementation, the method also includes requesting the image-manipulation server 16 to adjust the brightness of the thumbnails 24 based on an input to the printer 10. In the same or a different implementation, the method also includes requesting the image-manipulation server 16 to adjust the contrast of the thumbnails 24 based on an input to the printer 10. In one variation of the embodiment of FIG. 2, the screen 20 is a touch screen, a single brightness/contrast touch button 32 is displayed on the screen 20, and pressing button 32 clears existing touch buttons and brings up (displays) separate touch buttons to increase and decrease brightness and contrast and to return to the previously-displayed set of touch buttons. In one example, brightness (intensity) of the thumbnails 24 is adjusted according to the equation s=cr^{γ} wherein r is the input intensity, s is the output intensity, and c and γ are positive constants. Values for γ less than one have the effect of making the output lighter than the input while values for γ greater than one have the opposite effect.

In the same or a different implementation, the thumbnails are two-dimensional thumbnails, and the method also includes requesting the image-manipulation server 16 to convert the two-dimensional thumbnails to three-dimensional thumbnails based on an input to the printer 10. In one variation, the screen 20 is a touch screen, and input is provided by the user touching or pressing a 3D touch button 34 displayed on the screen 20. In one arrangement, a three-dimensional image is rendered using a method of volume data rendering. In one illustration, wherein the standard for medical image display is Maximum Intensity Projection (MIP), the intensity of each pixel in the MIP image is the maximum intensity encountered in the three-dimensional dataset along each of the parallel or divergent paths defined by viewpoint. In CT angiography, for example, MIP results in a two-dimensional image highlighting the vascular structures. The volume data rendering result is usually obtained by interactively adjusting the rendering parameters, such as the viewpoint (i.e., the orientation), the spatial region and/or the value range of interest of the volume data.

In the same or a different implementation, the screen 20 is a touch screen, and a print touch button 36 is displayed on the screen 20 to enable a user to request that the printer 10 print a selected medical image (such as one identified by a user touching one of the displayed thumbnails 24 to highlight that thumbnail). In one variation, an exit touch button 38 is also displayed on the screen 20 to enable a user of the printer 10 to return to (display) the printer main menu.

In one example of an extension of the method, as described in this paragraph, the screen 20 is a touch screen, and a user calls up (displays) a medical-imaging submenu (not shown) from the main-menu (not shown) displayed on the screen 20 of the printer 10. The user of the printer 10 interacts with the medical-imaging submenu displayed on the screen 20 to obtain a list of identifiers, such as patient names, from the database. It is noted that DICOM files contain both a header (which stores information including the patient's name, the type of scan, image dimensions, etc.) as well as all the image data (which can contain information in three dimensions). DICOM image data can be compressed (encapsulated) to reduce the image size. Files can be compressed using lossy or lossless variants of the JPEG (Joint Photographic Experts Group) format, as well as a lossless Run-Length Encoding format (which is similar to the packed-bits compression found in some TIFF [Tag Image File Format] format images). The image-manipulation server 16 runs a DICOM client software that communicates with the image-storage server 14. Through this connection, a list of patient records may be obtained. The list of patient records (not shown) may displayed on the screen 20 of the printer 10. The user of the printer 10 can scroll down the list of patients and select specific patient records for previewing. In one example, having the user touch a patient's name causes the names of groups of records (medical images) for that patient to be displayed, and having the user touch the name of a particular group of medical images (such as the X-rays of a certain date) provides an input to the screen 20 to request the image-manipulation server 16 obtain that group of medical images from the database. The patient images and data which are acquired from the image-storage server 14 by the image-manipulation server 16 are then displayed on the screen 20 of the printer 10 as thumbnails or thumbnail images 24. To do this, the printer 10 sends a request to the image-manipulation server 16 which communicates with the image-storage server 14 to acquire the appropriate DICOM files. The image-manipulation server 16 decodes the DICOM files and extracts image data. The image data can vary greatly in size and number of scans depending on the modality (e.g., X-ray or CT, etc.) and the clinical procedure. Usually image sizes are less than 1024×1024 pixels with 12 bits/pixel. These images may be reduced in size (128×128 pixels with 8 bits/pixel) by the image-manipulation server 16 and sent to be displayed as thumbnails 24 on the screen 20 of the printer 10. The number of images to be tiled and displayed as thumbnails 24 depends on the resolution of the touch screen 21 of the printer 10. Once the thumbnails 24 are displayed, the user can scroll through the thumbnails if there are more thumbnails to be viewed.

In one modification of the method, when the screen 20 is not a touch screen, or to augment when the screen 20 is a touch screen, the printer 10 includes at least one non-touch-screen input device (not shown) such as, without limitation, at least one touch pad, printer button, and/or joy stick.

A second aspect of the invention is a storage medium 40 containing a program readable by a computer 42 of a printer 10 operatively connectable to an image-manipulation server 16 operatively connectable to an image-storage server 14 storing a database of medical images and identifiers, such as names of patients, corresponding to the medical images. The program instructs the computer 42 to perform several steps. One step includes requesting the image-manipulation server 16 to obtain a group of medical images from the database for a patient identified by an input to the printer 10. Another step includes displaying, on a screen 20 of the printer 10, a thumbnail 24 of at least one medical image from the group. An additional step includes requesting the printer 10 to print a medical image corresponding to a thumbnail 24 identified by an input to the printer 10.

Examples of storage media 40 include, without limitation, hard drives, compact disks (CD's), and floppy disks.

A third aspect of the invention is a printer 10 including a screen 20 operatively connected to the computer 42. The computer 42 is operatively connectable to an image-manipulation server 16 which is operatively connectable to an image-storage server 14 storing a database of medical images and identifiers, such as names of patients, corresponding to the medical images. The computer 42 includes a program which instructs the computer 42 to perform several steps. One step includes requesting the image-manipulation server 16 to obtain a group of medical images from the database for a patient identified by an input to the printer 10. Another step includes displaying, on the screen 20, a thumbnail 24 of at least one medical image from the group. An additional step includes requesting the printer 10 to print a medical image corresponding to a thumbnail 24 identified by an input to the printer 10.

In one implementation of the second and/or third aspect of the invention, the computer 42 of the printer 10 is a printer Application Specific Integrated Circuit (ASIC). Other implementations are left to the artisan including those digital computers having embedded software to perform the above-described steps. It is noted that the illustrations, examples, implementations, of the method of the first aspect of the invention are equally applicable to the second and/or third aspect of the invention, wherein the language “the method also includes requesting the image-manipulation server 16 to” of the implementations of the method is replaced with “the program instructs the digital computer 42 to request the image-manipulation server 16 to”.

Several benefits and advantages are derived from at least one of the method, the printer, and the storage medium of the invention. In one example, having a printer interact with an image-manipulation server operatively connected to the image-storage server allows personnel to use a printer to retrieve medical images, to display thumbnails of such images, and to print such images without having first received extensive training and without having to operate a high-end graphical workstation.

The foregoing description of several aspects of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method for printing at a printer medical images stored in a database of an image-storage server connected to an image-manipulation server, the database including identifiers corresponding to the medical images, comprising the steps of:
a) requesting the image-manipulation server to obtain at least one medical image, the identifier of the at least one medical image corresponding to an input received at the printer;
b) displaying a thumbnail of the at least one medical image; and
c) printing, in response to a request to print a selected thumbnail, the medical image corresponding to the selected thumbnail.

2. The method of claim 1, wherein each of the medical images of the database is stored in a Digital Imaging and Communications in Medicine (DICOM) file format.

3. The method of claim 2, wherein the image-storage server is a Picture Archiving and Communication System (PACS) server.

4. The method of claim 1, wherein the group of medical images includes at least one from the group of X-ray images, Computed Tomography (CT) images, Magnetic Resonance (MR) images, UltraSound (US) images, single photon emission computed tomography (SPECT) images, and Positron Emission Tomography (PET) images.

5. The method of claim 1, further comprising requesting the image-manipulation server to perform an action on a selected thumbnail in response to input received at the printer.

6. The method of claim 5, wherein the action is enlarging the selected thumbnail.

7. The method of claim 1, further comprising requesting the image-manipulation server to adjust a characteristic of the thumbnail in response to an input received at the printer.

8. The method of claim 7, wherein the characteristic is brightness of the thumbnail.

9. The method of claim 7, wherein the characteristic is contrast of the thumbnail.

10. The method of claim 1, further comprising requesting the image-manipulation server to convert the thumbnail to a three-dimensional thumbnail in response input at the printer.

11. A storage medium containing a program, readable by a computer of a printer operatively connectable to an image-manipulation server operatively connectable to an image-storage server storing a database of medical images and identifiers corresponding to the medical images, which instructs the computer to perform the steps of:
a) requesting the image-manipulation server to obtain at least one medical image, the identifier of the at least one medical image corresponding to input received at the printer;
b) displaying, on a screen of the printer, a thumbnail of the at least one medical image; and
c) requesting the printer to print the medical image corresponding to a thumbnail identified by an input to the printer.

12. The storage medium of claim 11, wherein the medical images are stored in a Digital Imaging and Communications in Medicine (DICOM) file format, wherein the image-storage server is a Picture Archiving and Communication System (PACS) server, and wherein the medical images includes at least one from the group of X-ray images, Computed Tomography (CT) images, Magnetic Resonance (MR) images, UltraSound (US) images, single photon emission computed tomography (SPECT) images, and Positron Emission Tomography (PET) images.

13. The storage medium of claim 11, wherein the program instructs the computer to request the image-manipulation server to perform an action on a selected thumbnail in response to an input received at the printer.

14. The storage medium of claim 13, wherein the action is enlarging the selected thumbnail.

15. The storage medium of claim 11, wherein the program instructs the computer to request the image-manipulation server to adjust a characteristic of the thumbnail in response to an input received at the printer.

16. The storage medium of claim 15, wherein the characteristic is brightness of the thumbnail.

17. The storage medium of claim 15, wherein the characteristic is contrast of the thumbnail.

18. The storage medium of claim 11, wherein the program instructs the computer to request the image-manipulation server to convert the thumbnail to a three-dimensional thumbnail in response to input at the printer.

19. A printer comprising a computer and a screen operatively connected to the computer, the digital computer operatively connectable to an image-manipulation server which is operatively connectable to an image-storage server storing a database of medical images and identifiers corresponding to the medical images, the computer including a program which instructs the digital computer to perform the steps of:
a) requesting the image-manipulation server to obtain at least one medical image, the identifier of the at least one medical image corresponding to an input received at the printer;
b) displaying on the screen a thumbnail of at the least one medical image; and
c) requesting the printer to print a medical image corresponding to a thumbnail identified by an input to the printer.

20. The printer of claim 19, wherein medical images are stored in a Digital Imaging and Communications in Medicine (DICOM) file format, wherein the image-storage server is a Picture Archiving and Communication System (PACS) server, and wherein the medical images includes at least one from the group of X-ray images, Computed Tomography (CT) images, Magnetic Resonance (MR) images, UltraSound (US) images, single photon emission computed tomography (SPECT) images, and Positron Emission Tomography (PET) images.

21. The printer of claim 19, wherein the program instructs the computer to request the image-manipulation server to perform an action on a selected thumbnail in response to input received at the printer.

22. The printer of claim 19, wherein the program instructs the computer to request the image-manipulation server to adjust a characteristic of the thumbnail in response to an input received at the printer.
